(19) United States
(12) Patent Application Publication
(10) Pub. No.: US 2026/0338702 A1
(43) Pub. Date: Oct. 29, 2026

(54) APPLICATION STATE ANALYSIS SYSTEM AND METHOD THEREFOR

(71) Applicants: CAMEYE CO.LTD., Gyeongsan-si, Gyeongsangbuk-do (KR); INDUSTRY ACADEMIC COOPERATION FOUNDATION OF YEUNGNAM UNIVERSITY, Gyeongsan-si, Gyeongsangbuk-do (KR)

(72) Inventor: Chan Su LEE, Daegu (KR)

(73) Assignees: CAMEYE CO.LTD., Gyeongsan-si, Gyeongsangbuk-do (KR); INDUSTRY ACADEMIC COOPERATION FOUNDATION OF YEUNGNAM UNIVERSITY, Gyeongsan-si, Gyeongsangbuk-do (KR)

(21) Appl. No.: 19/115,114

(22) PCT Filed: Jul. 24, 2023
(86) PCT No.: PCT/KR2023/010641

§ 371 Date: Mar. 25, 2025

(30) Foreign Application Priority Data
Sep. 26, 2022 (KR) 10-2022-0121706

(51) Int. Cl. G01N 21/88; G01N 21/31; G06T 7/00; G06T 7/90; G06V 10/141; G06V 10/143; G06V 10/147; G06V 10/75

(52) U.S. Cl. CPC G01N 21/8851; G01N 21/3103; G06T 7/001; G06T 7/90; G06V 10/141; G06V 10/143; G06V 10/751; G01N 21/8806; G01N 2021/8887; G01N 2201/061; G06T 2207/10024; G06T 2207/10152; G06T 2207/30164; G06V 10/147

(57) ABSTRACT

The present invention relates to an application state analysis system and a method therefor and, more specifically, to a technique capable of analyzing the surface application state of a workpiece to which a coating solvent has been applied through an application means. In particular, the present invention relates to an application state analysis system and a method therefor, in which, in response to the color of a coating solvent, the color of light illuminated on a workpiece is controlled, thus allowing the accuracy and reliability of analysis results of the surface application state of the workpiece to be improved.

### TECHNICAL FIELD

The present invention relates to an application state analysis system and a method therefor, and more specifically, to an application state analysis system and a method therefor, in which the application state analysis system analyzes an application state to determine whether a reference amount or greater of a coating solvent (coating liquid) is applied to a surface of a workpiece (object to be applied), and there is no problem in performing a minimum required function after application.

In particular, the present invention relates to an application state analysis system and a method therefor, in which, in response to a color of a coating solvent, a color of lighting illuminated on a workpiece is controlled, thereby improving accuracy and reliability of analysis results of a surface application state of the workpiece.

### BACKGROUND ART

In general, an application state may be analyzed by inspecting/determining uniformity of the coating solvent applied to the surface of the workpiece, and to this end, a flat image of the workpiece or a single-layer image is acquired, and the uniformity of the application state is inspected.

However, when the coating solvent applied to the surface of the workpiece is in the form of a spray, it is difficult to determine the application due to the fine particles, and it is affected by lighting and surrounding light, and in general, light is reflected not only through the applied surface but also through a background (surrounding environment) where the workpiece is located, so that it difficult to determine a difference depending on the application. As a result, the accuracy of uniformity inspection is reduced because an accurate image may not be acquired. In addition, the accuracy of uniformity inspection is reduced because differences in brightness occur due to unique characteristics (shape, etc.) of the workpiece when light is illuminated to acquire an image, so that it is difficult to acquire the accurate image.

In addition, prior art (Korean Registered Patent No. 10-1640425) discloses a technology capable of automatically setting inspection regions for all images by setting the inspection region only once, without setting the inspection region each time for each image, when an application state of a sealer is inspected based on based on a plurality of images of the sealer application state.

The technology also does not take into account any problems that may arise during the process of acquiring the acquired image.

### DISCLOSURE

### Technical Problem

The present invention has been made to solve the problems of the related art as described above, and an object of the present invention is to provide an application state analysis system and a method therefor, in which the application state analysis system may relatively and accurately analyze a surface application state of a workpiece by controlling a color of lighting illuminated on the workpiece in response to a color of a coating solvent.

### Technical Solution

An application state analysis system according to one embodiment of the present invention, which analyzes a surface application state of a workpiece to which a coating solvent is applied through an application unit, may include: a lighting module configured to collectively control at least two light source units such that lights having mutually different spectral components are illuminated through the at least two light source units in a first light emitting state and a second light emitting state; a vision module configured to photograph each workpiece on which the light is illuminated by the lighting module according to the light emitting state to acquire at least two image data; an application concentration analysis module configured to calculate a color value for each pixel constituting each image data using a weight value preset for an RGB channel, and calculate a difference in the color value between matching pixels of the two image data to set the difference in the color value as an application concentration value of a corresponding pixel; an application concentration determination module configured to determine a defective application state when the set application concentration value is out of a preset threshold reference value; and an integrated control module configured to control each operation state by generating control signals for the lighting module, the vision module, the application concentration analysis module, and the application concentration determination module.

In addition, the integrated control module may control the lighting module in a preset basic light emitting state, and control the vision module to acquire basic image data about an entire region of the workpiece on which the light is illuminated according to the basic light emitting state.

In addition, the integrated control module may analyze the basic image data obtained in the entire image acquisition step (S10) to generate a control signal for a first light emitting state having a spectrum that reflects the coating solvent applied to the workpiece and generate a control signal for a second light emitting state having a spectrum that does not reflect the coating solvent applied to the workpiece, in order to control the lighting module.

In addition, the integrated control module may analyze the basic image data to perform additional control of the first and second light emitting states of the lighting module by generating a control signal for an illumination state for each preset inspection region of the workpiece.

In addition, the integrated control module may sequentially generate the control signals for the lighting module, the vision module, the application concentration analysis module, and the application concentration determination module for each preset inspection region of the workpiece to separately control the operation state.

In addition, the vision module may include at least two lenses of mutually different types, and selectively acquire image data of the entire region, a preset wide inspection region, or a preset narrow inspection region of the workpiece according to the control signal of the integrated control module.

In addition, the application concentration analysis module may detect feature points of each image data and match pixels through feature point matching by using a pre-stored image processing technique.

In addition, the application concentration analysis module may generate a mask based on the preset inspection region of the workpiece and perform a masking process on each image data by using a pre-stored image processing technique.

In addition, the application concentration determination module may determine a normal application state or defective application state of a corresponding region for each preset inspection region of the workpiece by using a ratio of a number of pixels determined as the defective application state with respect to a total number of pixels in each region.

In addition, the application concentration determination module may finally determine the workpiece as a defective product when the defective application state is determined in any one region of an entire inspection region of the workpiece.

In addition, the application concentration determination module may calculate an application concentration score of a corresponding region for each preset inspection region of the workpiece by using a ratio of a number of pixels determined as the defective application state with respect to a total number of pixels in each region, and use a sum value or average value of the application concentration score for an entire inspection region of the workpiece to finally determine the workpiece as a defective product when the sum value or the average value is out of a preset value range.

In addition, the application state analysis system may further include a result processing module configured to output an alarm to an outside when a final determination result of the workpiece by the application concentration determination module is the defective product.

An application state analysis method according to one embodiment of the present invention, which analyzes a surface application state of a workpiece to which a coating solvent is applied through an application unit, may include: a lighting control step (S100) by a lighting module for collectively controlling at least two light source units such that lights having mutually different spectral components are illuminated through the at least two light source units in a first light emitting state and a second light emitting state by control signals; a vision control step (S200) by a vision module for photographing each workpiece on which the light is illuminated according to the light emitting state in the lighting control step (S100) to acquire at least two image data using the control signal; an application concentration analysis step (S300) by an application concentration analysis module for calculating a color value for each pixel constituting each image data, which is acquired in the vision control step (S200), using a weight value preset for an RGB channel, and calculating a difference in the color value between matching pixels of the two image data to set the difference in the color value as an application concentration value of a corresponding pixel using the control signal; and an application concentration determination step (S400) by an application concentration determination module for determining a defective application state using the control signal when the application concentration value set in the application concentration analysis step (S300) is out of a preset threshold reference value, in which operations of the lighting control step (S100), the vision control step (S200), the application concentration analysis step (S300), and the application concentration determination step (S400) are sequentially repeated for each preset inspection region of the workpiece by the control signal.

In addition, the application state analysis method may further include: an entire image acquisition step (S10) for, upon an initial operation, integrally controlling the light source unit in a preset basic light emitting state using the control signal by the lighting module, and acquiring basic image data for an entire region of the workpiece on which the light is illuminated according to the basic light emitting state using the control signal by the vision module.

In addition, the application state analysis method may further include: a lighting control step (S20) for analyzing the basic image data obtained in the entire image acquisition step (S10) to generate a control signal for the first light emitting state having a spectrum that reflects the coating solvent applied to the workpiece and generate a control signal for the second light emitting state having a spectrum that does not reflect the coating solvent applied to the workpiece, in order to control the lighting module.

In addition, the application state analysis method may further include: a lighting addition control step (S30) for analyzing the basic image data obtained in the entire image acquisition step (S10) to generate a control signal for an illumination state in order to additionally control the first light emitting state and the second light emitting state of the lighting module for each predetermined inspection region of the workpiece.

In addition, the vision control step (S200) may control the vision module including at least two lenses of mutually different types to selectively acquire image data of an entire region, a preset wide inspection region, or a preset narrow inspection region of the workpiece.

In addition, the application concentration analysis step (S300) may detect feature points of each image data and match pixels through feature point matching by using a pre-stored image processing technique.

In addition, the application concentration analysis module may generate a mask based on the preset inspection region of the workpiece and perform a masking process on each image data by using a pre-stored image processing technique.

In addition, the application concentration determination step (S400) may determine a normal application state or defective application state of a corresponding region for each preset inspection region of the workpiece by using a ratio of a number of pixels determined as the defective application state with respect to a total number of pixels in each region.

In addition, the application concentration determination step (S400) may finally determine the workpiece as a defective product when the defective application state is determined in any one region of an entire inspection region of the workpiece.

In addition, the application concentration determination step (S400) may calculate an application concentration score of a corresponding region for each preset inspection region of the workpiece by using a ratio of a number of pixels determined as the defective application state with respect to a total number of pixels in each region, and use a sum value or average value of the application concentration score for an entire inspection region of the workpiece to finally determine the workpiece as a defective product when the sum value or the average value is out of a preset value range.

### Advantageous Effects

The application state analysis system and the method therefor of the present invention with the above configuration may relatively and accurately analyze the surface application state of the workpiece to which the coating solvent is applied through an application unit by controlling a color of lighting illuminated on the workpiece in response to a color of the coating solvent.

### DESCRIPTION OF DRAWINGS

FIG. 1 is a view illustrating a configuration of an application state analysis system according to one embodiment of the present invention.

FIG. 2 is an application state analysis image for any one inspection region of a workpiece selected from the application state analysis system and a method therefor according to one embodiment of the present invention, which is an exemplary image showing normal application and abnormal application.

FIGS. 3 and 4 are exemplary images showing overall inspection result information according to application state analysis results for each inspection region of the workpiece in the application state analysis system and the method therefor according to one embodiment of the present invention.

FIG. 5 is a flowchart illustrating the application state analysis method according to one embodiment of the present invention.

### MODE FOR INVENTION

Hereinafter, an application state analysis system and a method therefor will be described in detail with reference to the accompanying drawings. The drawings introduced below are provided as examples to ensure that the spirit of the present invention may be sufficiently delivered to those skilled in the art. Therefore, the present invention is not limited to the drawings present below and may be embodied in other forms. In addition, the same reference numerals represent the same components throughout the specification.

In this case, technical terms and scientific terms used herein have the general meaning understood by those skilled in the art to which the present invention pertains unless otherwise defined, and a description for the known function and configuration obscuring the present invention will be omitted in the following description and the accompanying drawings.

In addition, a system refers to a set of components including devices, mechanisms, and units that are organized and interact regularly to perform necessary functions.

The application state analysis system and the method therefor according to one embodiment of the present invention relates to a technology capable of relatively and accurately analyzing a surface application state of a workpiece to which a coating solvent is applied through an application unit by controlling a color of lighting illuminated on the workpiece in response to a color of the coating solvent.

The coating solvent described in general refers to a substance that is applied to a surface of the workpiece to achieve a predetermined purpose (function) of the workpiece, and the application concentration refers to a ratio of an area to which the coating solvent is applied with respect to the total area to be applied, which is expressed as a percentage, when the coating solvent, such as an adhesive or paint, is applied to the surface of the workpiece by spraying or a similar method. In addition, a normal application state to be determined means an amount (application concentration) applied to the surface of the workpiece such that there is no problem in achieving the minimum function (object) that the coating solvent is intended to perform.

In view of these points, an application state analysis system according to one embodiment of the present invention will be described.

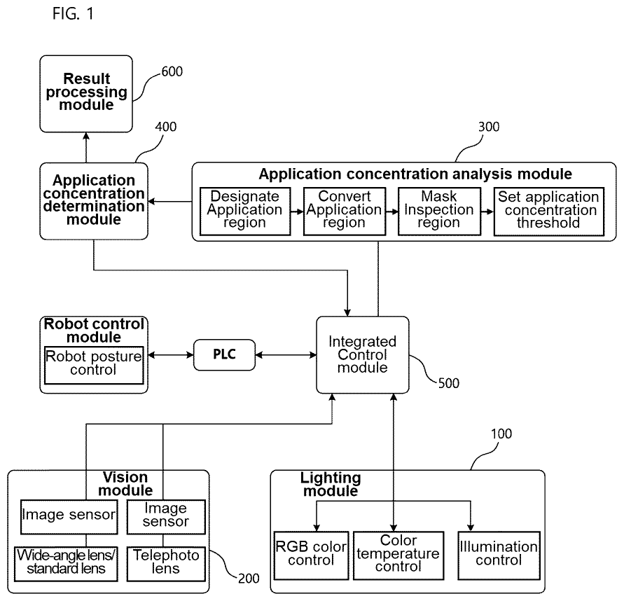

As illustrated in FIG. 1, the application state analysis system according to one embodiment of the present invention includes a lighting module 100, a vision module 200, an application concentration analysis module 300, an application concentration determination module 400, and an integrated control module 500, and the components are preferably included in a computation processing unit including a computer, a CPU, etc., to perform operations. The components may be connected using power line communication (PLC) communication, but the present invention is not necessarily limited to the PLC communication.

In more detail about each component,

The operation states of the lighting module 100, the vision module 200, the application concentration analysis module 300, and the application concentration determination module 400 are controlled according to a control signal of the integrated control module 500.

That is, the integrated control module 500 generates control signals for the lighting module 100, the vision module 200, the application concentration analysis module 300, and the application concentration determination module 400, and controls each operation state. That is, the operation of each module may be controlled through the integrated control module 500, and as described above, each module may be connected using PLC communication, etc.

In addition, the integrated control module 500 may sequentially generate control signals for the lighting module 100, the vision module 200, the application concentration analysis module 300, and the application concentration determination module 400 for each preset inspection region of the workpiece in controlling each operation state, thereby separately controlling and managing the operation state of each inspection region.

The lighting module 100 illuminates light having mutually different spectral components through at least two light source unit capable of controlling RGB colors. This is controlled in a first light emitting state and a second light emitting state according to the control signal of the integrated control module 500.

The lighting module 100 may control each light source unit such that the light is uniformly illuminated on the entire region of the workpiece.

The light source unit capable of controlling RGB colors may control a color illuminated on a workpiece in response to a color of the coating solvent. Specifically, the color of the coating solvent may be controlled to a spectrum that reflects the color of the coating solvent well (first light emitting state) and a spectrum that does not reflect the color of the coating solvent (second light emitting state), and thus a surface condition of the applied workpiece may be easily and accurately determined.

The vision module 200 may photograph the workpiece on which the light is illuminated by the lighting module 100 according to the light emitting states (first light emitting state and second light emitting state) to acquire at least two image data.

That is, image data in the first light emitting state and image data in the second light emitting state are acquired.

In this case, as illustrated in FIG. 1, the vision module 200 may include at least two lens units of mutually different types, and includes one lens unit composed of a wide-angle lens or a standard lens, another lens unit composed of a telephoto lens (zoom lens), an image sensor unit connected to each lens unit, a data line, etc. The vision module 200 selects the lens unit for acquiring image data one by one or simultaneously according to the control signal from the integrated control module 500, thereby sequentially or simultaneously acquiring the image data.

Accordingly, when one lens unit composed of a wide-angle lens or a standard lens is selected, image data about the entire region of the workpiece may be acquired, and when another lens unit composed of a telephoto lens is selected, image data for each preset inspection region obtained by dividing the entire region of the workpiece may be acquired. That is, the vision module 200 may acquire image data about the entire region, a preset wide inspection region, or a preset narrow inspection region of the workpiece according to the control signal of the integrated control module 500.

In this case, the application state analysis system according to one embodiment of the present invention may control the lighting module 100 according to the control signal of the integrated control module 500, and control the light source unit in a preset basic light emitting state upon an initial operation, in order to analyze the best application state for each workpiece.

In this case, the expression “preset basic light emitting state” literally means the basic lighting, but the present invention is not limited thereto.

Subsequently, the vision module 200 is controlled according to the control signal of the integrated control module 500 to acquire basic image data about the entire region of the workpiece on which light is illuminated according to the basic light emitting state of the lighting module 100.

The integrated control module 500 analyzes the acquired basic image data to generate a control signal for controlling the lighting module 100, that is, a control signal for controlling the lighting module 100 in the first light emitting state and a control signal for controlling the lighting module 100 in the second light emitting state.

To this end, the integrated control module 500 analyzes the acquired basic image data to set a light emitting state, which has a spectrum that reflects the coating solvent applied to the workpiece, as a first light emitting state, and set a light emitting state, which has a spectrum that does not reflect the coating solvent applied to the workpiece, as a second light emitting state.

Since the set spectrum of each light emitting state is different depending on the coating solvent applied to the workpiece, the present invention is not limited to the spectrum, but is limited to controlling the light emitting state such that the lighting for illuminating the workpiece corresponding to the coating solvent has a spectrum that reflects the color of the coating solvent well, or controlling the light emitting state such that the lighting for illuminating the workpiece corresponding to the coating solvent has a spectrum that does not reflect the color of the coating solvent.

To this end, the lighting module 100 may include a light source unit capable of controlling a color temperature as illustrated in FIG. 1, in addition to the light source unit capable of controlling the RGB colors described above, to perform additional control of the first and second light emitting states through the color temperature control.

The light source unit capable of controlling the color temperature may be configured by utilizing a combination of low color temperature lighting (Warm White) and high color temperature lighting (Cool White) to adjust/control the color temperature. Accordingly, it is possible to induce a change in distribution of the lighting spectrum in the continuous spectrum.

In addition, even if the same light is illuminated according to an outline shape of the workpiece, a surface material of the workpiece, and the like, a difference in saturations for each inspection region is inevitably generated. In view of this point, the integrated control module 500 may analyze the acquired basic image data to perform additional control of the first and second light emitting states of the lighting module 100 by generating a control signal for an illumination state for each preset inspection region of the workpiece.

Through the illuminance control, it is possible to control the amount of light of the light source unit that illuminates light to the workpiece. As described above, it is possible to control the illuminance differently for each inspection region of the workpiece, and accordingly, it is possible to accurately measure an application concentration in each inspection region.

More specifically, the more the light that is illuminated from the light source unit is reflected on the workpiece and enters the image sensor (camera, etc.), the higher the saturation is even for a surface having the same application concentration. To solve this problem, different saturations for each inspection region may be uniformly corrected through the illuminance control.

Accordingly, the lighting module 100 controls the light source unit in the first light emitting state, which has a spectrum that reflects the color of the coating solvent well, according to the control signal of the integrated control module 500, so that the vision module 200 photographs the workpiece on which the light is illuminated according to the first light emitting state. Moreover, the lighting module 100 controls the light source unit in the second light emitting state, which has a spectrum that does not reflect the color of the coating solvent, according to the control signal of the integrated control module 500, so that the vision module 200 photographs the workpiece on which the light is illuminated according to the second light emitting state.

The application concentration analysis module 300 may calculate a color value for each pixel constituting each image data (image data in the first light emitting state and image data in the second light emitting state) acquired by the vision module 200 by using a weight value preset for the RGB channel.

That is, the color value of each pixel is calculated by analyzing the color based on the RGB channel for each pixel and applying the preset weight value to the RGB channel.

In this case, since the color value of the pixel for each image data is calculated, a color value difference between matched pixels of two image data may be calculated.

The calculated difference value may be set as an application concentration value of the corresponding pixel.

The calculated difference value for each pixel is set as the application concentration value using an analysis due to a difference in light emitting state of the lighting module 100, and it is possible to set an application concentration value that may determine sufficient application of the coating solvent through the color value difference of the two image data.

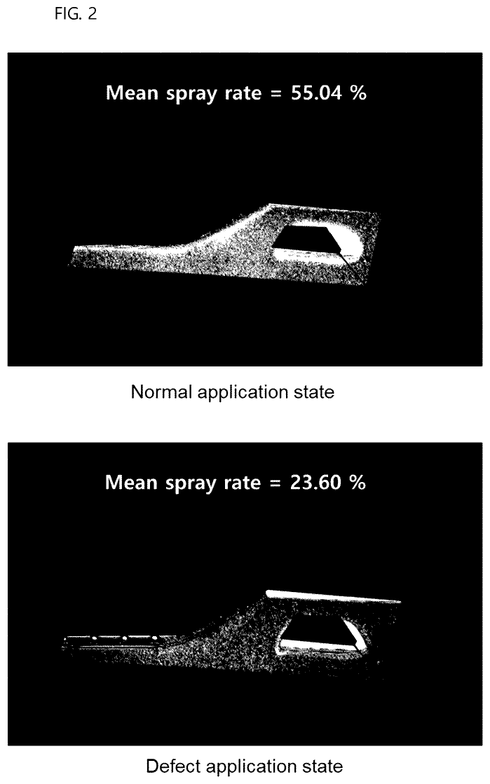

For example, when the coating solvent is not sufficiently applied, since a difference between the color value of the image data obtained in the first light emitting state and the color value of the image data obtained in the second light emitting state hardly occurs, the application concentration value is set to be low. That is, the low application concentration value means a thin application state. Therefore, as illustrated in FIG. 2, a difference between application concentration values according to a normal application state and a defective application state occurs.

Specifically, as illustrated in FIG. 1, the application concentration analysis module 300 performs an application region designation function, an application region conversion function, an inspection region masking function, and an application concentration threshold setting function.

The application region designation function means a designation for a region where the application concentration is to be inspected, which means selecting in advance a region to be inspected among inspection regions preset for each workpiece and designating a coordinate range.

In this case, the coordinate range may be designated in a polygon or a curve according to the inspection region preset for each workpiece, and when the coordinate range is designated in a curve, the coordinate range may be designated by approximating the curve to an inscribed or circumscribed polygon.

The application region conversion function may detect feature points of each image data and match pixels through feature point matching by using a pre-stored image processing technique.

In particular, when the workpiece is not fixed according to a working process of the workpiece and the workpiece itself is moved through a conveyor belt or the like during application of the coating solvent through an application unit, the image data acquired in the first light emitting state and the image data acquired in the second light emitting state have different position coordinates.

In this case, the pixels may match through feature point matching by detecting feature points of each image data.

Obviously, even if the image data acquired in the first light emitting state and the image data acquired in the second light emitting state are acquired in a state in which the workpiece is fixed, since the image sensor may have different position coordinates according to a mounting position of the image sensor, the pixels may match through feature point matching by detecting the feature points of each image data.

As the pre-stored image processing technique, a technique of detecting a basic feature such as a corner point or detecting a complex feature such as a histogram of oriented gradients (HOG) may be applied, and a type of the image processing technique is not limited to a typical image processing technique.

However, in a process of matching pixels through feature point matching after detecting the feature points, a mask may be generated based on the inspection region such that feature points located in a peripheral portion of the inspection region may be found and matched in order to reduce an error in feature point matching. Thereafter, the mask is finally set to match only the feature points around the inspection region through dilation and erosion operations of the mask, thereby improving the accuracy of feature point matching.

The inspection region masking function may perform a mask function using a pre-stored image processing technique such that image processing may be performed on only the inspection region in calculating a color value difference between matching pixels of image data according to different lighting emitting states (the first emitting state and the second emitting state). Accordingly, through the masking processing of each image data, it is possible to prevent the difference value of the inspection region other than the corresponding inspection region from affecting the setting of the application concentration value.

In this case, the pre-stored image processing technique is a general image processing technique, but the present invention is not limited to the type thereof.

The application concentration threshold setting function is to set a reference for determining a defective application state in the application concentration determination module 400, and in the present invention, the application concentration is set to be about 50% using a standard sample, but this is merely one embodiment of the present invention, and may be set differently according to the purpose/function of the workpiece and a predetermined purpose/function of the coating solvent, but the present invention is not limited thereto.

The application concentration determination module 400 determines that the corresponding pixel is in a defective application state when the application concentration value set for each pixel is out of a preset threshold reference value. In this case, the preset threshold reference value is set to 50% according to the above-described technical features, but the present invention is not limited thereto. In addition, when a range of the application concentration is set to a range that may increase or decrease from the reference application concentration, for example, 50%, the range of the application concentration may be set to a range of the application concentration (threshold reference value, threshold reference value range) of 40% to 60% based on the reference application concentration. Obviously, the reference application concentration or the application concentration range using the same may be set differently for each workpiece and for each inspection region of the workpiece.

Accordingly, the application concentration determination module 400 determines the defective application state when the application concentration value obtained by the application concentration analysis module 300 for each inspection region and each pixel is out of a preset threshold reference value.

Specifically, the application concentration determination module 400 may calculate an application concentration score of the corresponding inspection region for each preset inspection region of the workpiece by using a ratio of the number of pixels determined as the defective application state with respect to the total number of pixels in each region, and determine that the corresponding inspection region corresponds to the normal application state or the defective application state through the application concentration score by using a preset determination reference ratio.

For example, when ten pixels are included in the selected inspection region and seven pixels among the ten pixels have the application concentration value of equal to or less than 50%, the application concentration score of the corresponding inspection region is 70%, which is a ratio of the defective application state. The normal application state or defective application state of the corresponding inspection region is determined according to the preset determination reference ratio.

In this case, the preset determination reference ratio may also be set differently according to the purpose/function of the workpiece and the predetermined purpose/function of the coating solvent, but the present invention is not limited thereto. That is, according to the preset determination reference ratio, even if the ratio of the normal application state of all pixels with respect to the corresponding inspection region is only 30%, it may be determined as the normal application state.

However, the application concentration determination module 400 may finally determine the workpiece as a defective product when the defective application state is determined in any one region of the entire inspection region of the workpiece.

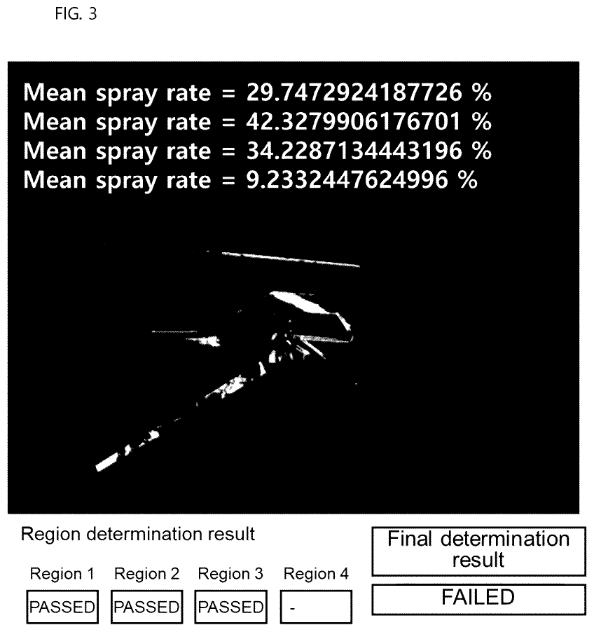

That is, referring to FIG. 3, regions 1 to 3 are analyzed as normal application states, but region 4 is analyzed as a defective application state, so that as a result of the entire inspection of the workpiece, the workpiece is finally determined as a defective product.

For another example, the application concentration determination module 400 calculates an application concentration score of the corresponding region for each preset inspection region of the workpiece by using a ratio of a number of pixels determined as the defective application state with respect to a total number of pixels in each region, and uses a sum value or average value of the application concentration score for an entire inspection region of the workpiece to finally determine the workpiece as a defective product when the sum value or the average value is out of a preset value range.

In other words, when the ratios of the defective application states of the respective inspection regions are summed up or averaged and are out of the predetermined value range, the workpiece is finally determined as a defective product.

Accordingly, although it is not determined as the defective application state for the individual inspection regions, it may be analyzed that determination close to defective application has been made in a plurality of inspection regions when the total score (sum value or average value) is out of the predetermined value range.

In this case, the preset predetermined value may also be set differently according to the purpose/function of the workpiece and the predetermined purpose/function of the coating solvent, but the present invention is not limited thereto.

As illustrated in FIG. 1, the application state analysis system according to one embodiment of the present invention further includes a result processing module 600.

The result processing module 600 may output an alarm to the outside when the final determination result of the workpiece, which is obtained by the application concentration determination module 400, is a defective product.

In addition, the result processing module 600 may notify a defect through the integrated control module 500 connected to the Ethernet so that a follow-up action may be performed.

The application state analysis system according to one embodiment of the present invention may further include a history storage module (not illustrated) that collects, stores, and manages all image data generated or transmitted/received by each module.

The history storage module may collect, store, and manage time series image data, which is obtained by recording a process of performing the operation of the application state analysis system according to one embodiment of the present invention, in addition to the image data generated or transmitted/received by each module.

Accordingly, it is possible to improve reliability of the application state analysis result, and it is possible to easily manage the history of the workpiece determined as a defective application state.

Further, as illustrated in FIG. 1, the application state analysis system according to one embodiment of the present invention may further include a robot control module.

The robot control module may perform a function of controlling a robot, which is an application unit interworking with the lighting module 100 and the vision module 200, interworking with an automatic application robot system, in order to operate the application state analysis system according to one embodiment of the present invention.

For example, when the robot, which is an application unit, performs an application operation and takes a posture at a predetermined position, the integrated control module 500 receives information about the posture, determines that the application operation is to be completed, and generates a control signal for analyzing a surface application state of the workpiece.

In addition, when the application state analysis of any one of the applied workpieces is completed, the integrated control module 500 may transmit a control signal to the robot control module such that the robot control module may perform the next work associated therewith.

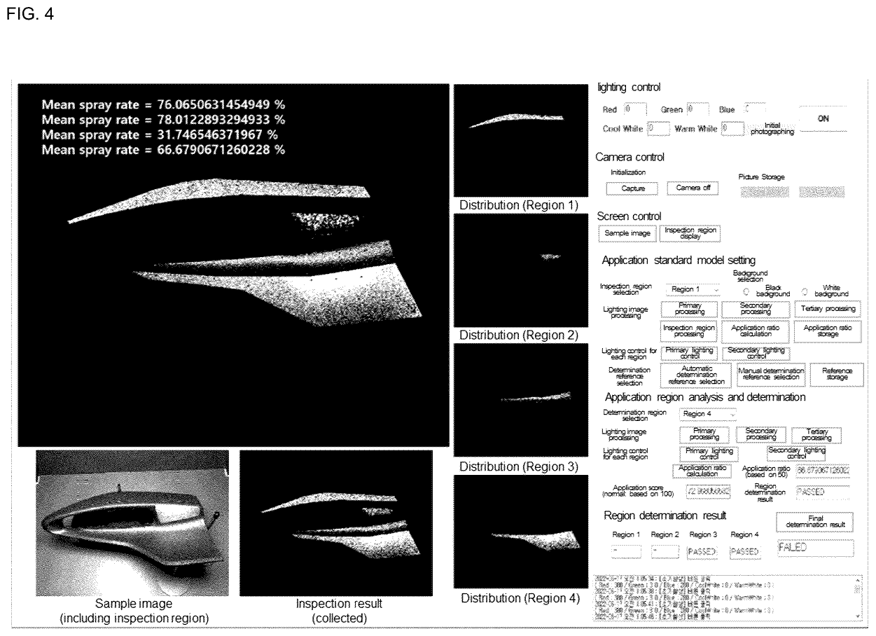

In addition, the application state analysis system according to one embodiment of the present invention may generate result information as illustrated in FIG. 4 according to a preset form of image data generated or transmitted/received by each module, and transmit the generated result information to an external monitoring module (not illustrated) associated therewith.

In this case, the external monitoring module may include various terminals, but the present invention is not limited thereto.

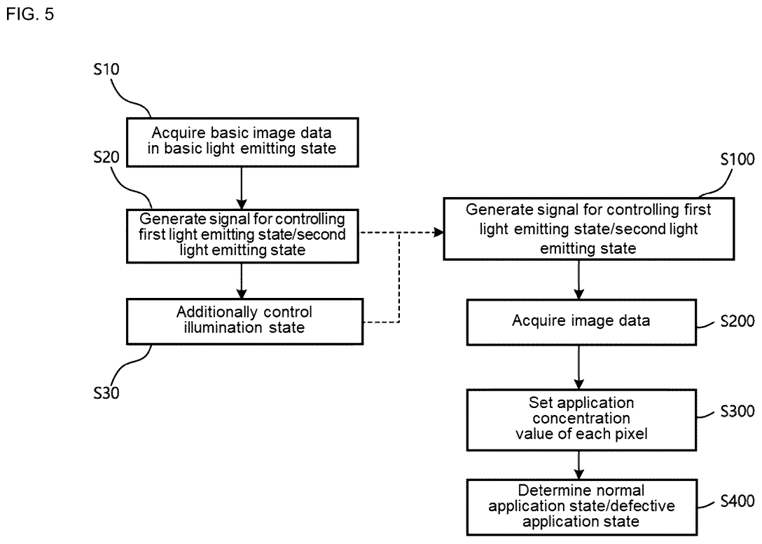

FIG. 5 is a flowchart illustrating an application state analysis method according to one embodiment of the present invention.

As illustrated in FIG. 5, the application state analysis method according to one embodiment of the present invention includes a lighting control step S100, a vision control step S200, an application concentration analysis step S300, and an application concentration determination step S400.

Each step is performed through the application state analysis system in which the operation is performed by a calculation processing unit, and operations of the lighting control step S100, the vision control step S200, the application concentration analysis step S300, and the application concentration determination step S400 may be sequentially repeated for each preset inspection region of the workpiece by the control signal of the integrated control module 500.

In more detail about each step,

In the lighting control step S100, the lighting module 100 includes at least two light source units of mutually different types, and collectively controls the at least two light source units in a first light emitting state and a second light emitting state using a control signal of the integrated control module 500.

In this case, the first light emitting state and the second light emitting state are set through separate operations upon an initial operation of the initial operation of the application state analysis method.

To this end, as illustrated in FIG. 5, the application state analysis method according to one embodiment of the present invention further includes an entire image acquisition step S10, a lighting control step S20, and a lighting additional control step S30, in order to perform the best application state analysis for each workpiece.

In the entire image acquisition step S10, the lighting module 100 integrally controls the light source unit in a preset basic light emitting state using the control signal of the integrated control module 500, and the vision module 200 acquires basic image data for the entire region of the workpiece on which the light is illuminated according to the basic light emitting state using the control signal of the integrated control module 500.

The lighting control step S20 analyzes the basic image data obtained in the entire image acquisition step S10 to generate a control signal for the first light emitting state having a spectrum that reflects the coating solvent applied to the workpiece and generate a control signal for the second light emitting state having a spectrum that does not reflect the coating solvent applied to the workpiece, in order to control the lighting module 100.

Specifically, the acquired basic image data is analyzed to set a light emitting state, which has a spectrum that reflects the coating solvent applied to the workpiece, as a first light emitting state, and set a light emitting state, which has a spectrum that does not reflect the coating solvent applied to the workpiece, as a second light emitting state.

Since the set spectrum of each light emitting state is different depending on the coating solvent applied to the workpiece, the present invention is not limited to the spectrum, but is limited to controlling the light emitting state such that the lighting for illuminating the workpiece corresponding to the coating solvent has a spectrum that reflects the color of the coating solvent well, or controlling the light emitting state such that the lighting for illuminating the workpiece corresponding to the coating solvent has a spectrum that does not reflect the color of the coating solvent.

In addition, even if the same light is illuminated according to an outline shape of the workpiece, a surface material of the workpiece, and the like, a difference in saturations for each inspection region is inevitably generated. In view of this point, through the additional lighting control step S30, the basic image data obtained in the entire image acquisition step S10 is analyzed to generate a control signal for an illuminance state or a control signal for a color temperature for each preset inspection region of the workpiece, in order to additionally control the first light emitting state and the second light emitting state of the lighting module 100.

The light source unit capable of controlling the color temperature may be configured by utilizing a combination of low color temperature lighting (Warm White) and high color temperature lighting (Cool White) to adjust/control the color temperature. Accordingly, it is possible to induce a change in distribution of the lighting spectrum in the continuous spectrum.

Through the illuminance control, it is possible to control the amount of light of the light source unit that illuminates light to the workpiece. As described above, it is possible to control the illuminance differently for each inspection region of the workpiece, and accordingly, it is possible to accurately measure an application concentration in each inspection region.

More specifically, as the light illuminated from the light source unit is reflected by the workpiece and enters the image sensor (camera, etc.), a surface having the same application concentration has a higher chroma. To solve this problem, it is preferable to uniformly correct different saturations for each inspection region through the illuminance control.

In the lighting control step S100, the light source unit is controlled in the first light emitting state, which has a spectrum that reflects the color of the coating solvent well, or the light source unit is controlled in the second light emitting state, which has a spectrum that does not reflect the color of the coating solvent.

In the vision control step S200, the vision module 200 photographs each workpiece on which light is illuminated according to the light emitting state (first light emitting state/second light emitting state) obtained in the lighting control step S100 to acquire at least two image data using the control signal of the integrated control module 500.

That is, image data in the first light emitting state and image data in the second light emitting state are acquired.

In this case, in the vision control step S200, the vision module including at least two lenses of mutually different types is controlled to sequentially or simultaneously acquire image data for the entire region or a preset inspection region of the workpiece by selecting the at least two lenses one by one or simultaneously.

Accordingly, when one lens unit composed of a wide-angle lens or a standard lens is selected, image data about the entire region of the workpiece may be acquired, and when another lens unit composed of a telephoto lens is selected, image data for each preset inspection region obtained by dividing the entire region of the workpiece may be acquired. That is, the vision control step S200 may acquire image data about the entire region, a preset wide inspection region, or a preset narrow inspection region of the workpiece according to the control signal of the integrated control module 500.

In the application concentration analysis step S300, the application concentration analysis module 300 calculates a color value for each pixel constituting each image data, which is acquired in the vision control step S200, using a weight value preset for an RGB channel, and calculates a difference in the color value between matching pixels of the two image data to set the difference in the color value as an application concentration value of the corresponding pixel using the control signal of the integrated control module 500.

That is, the color value of each pixel is calculated by analyzing the color based on the RGB channel for each pixel and applying the preset weight value to the RGB channel.

In this case, since the color value of the pixel for each image data is calculated, a color value difference between matched pixels of two image data may be calculated.

The calculated difference value may be set as an application concentration value of the corresponding pixel.

The calculated difference value for each pixel is set as the application concentration value using an analysis due to a difference in light emitting state in the lighting control step S100, and it is possible to set an application concentration value that may determine sufficient application of the coating solvent through the color value difference of the two image data.

For example, when the coating solvent is not sufficiently applied, since a difference between the color value of the image data obtained in the first light emitting state and the color value of the image data obtained in the second light emitting state hardly occurs, the application concentration value is set to be low. That is, the low application concentration value means a thin application state. Therefore, as illustrated in FIG. 2, a difference between application concentration values according to a normal application state and a defective application state occurs.

Specifically, the application concentration analysis step S300 performs an application region designation function, an application region conversion function, an inspection region masking function, and an application concentration threshold setting function.

The application region designation function means a designation for a region where the application concentration is to be inspected, which means selecting in advance a region to be inspected among inspection regions preset for each workpiece and designating a coordinate range.

In this case, the coordinate range may be designated in a polygon or a curve according to the inspection region preset for each workpiece, and when the coordinate range is designated in a curve, the coordinate range may be designated by approximating the curve to an inscribed or circumscribed polygon.

The application region conversion function may detect feature points of each image data and match pixels through feature point matching by using a pre-stored image processing technique.

In particular, when the workpiece is not fixed according to a working process of the workpiece and the workpiece itself is moved through a conveyor belt or the like during application of the coating solvent through an application unit, the image data acquired in the first light emitting state and the image data acquired in the second light emitting state have different position coordinates.

In this case, the pixels may match through feature point matching by detecting the feature points of each image data.

Obviously, even if the image data acquired in the first light emitting state and the image data acquired in the second light emitting state are acquired in a state in which the workpiece is fixed, since the image sensor may have different position coordinates according to a mounting position of the image sensor, the pixels may match through feature point matching by detecting the feature points of each image data.

As the pre-stored image processing technique, a technique of detecting a basic feature such as a corner point or detecting a complex feature such as a histogram of oriented gradients (HOG) may be applied, and a type of the image processing technique is not limited to a typical image processing technique.

However, in a process of matching pixels through feature point matching after detecting the feature points, a mask may be generated based on the inspection region such that feature points located in a peripheral portion of the inspection region may be found and matched in order to reduce an error in feature point matching. Thereafter, the mask is finally set to match only the feature points around the inspection region through dilation and erosion operations of the mask, thereby improving the accuracy of feature point matching.

The inspection region masking function may perform a mask function using a pre-stored image processing technique such that image processing may be performed on only the inspection region in calculating a color value difference between matching pixels of image data according to different lighting emitting states (the first emitting state and the second emitting state). Accordingly, through the masking processing of each image data, it is possible to prevent the difference value of the inspection region other than the corresponding inspection region from affecting the setting of the application concentration value.

In this case, the pre-stored image processing technique is a general image processing technique, but the present invention is not limited to the type thereof.

The application concentration threshold setting function is to set a reference for determining a defective application state in the application concentration determination step S400, and in the present invention, the application concentration is set to be about 50% using a standard sample, but this is merely one embodiment of the present invention, and may be set differently according to the purpose/function of the workpiece and a predetermined purpose/function of the coating solvent, but the present invention is not limited thereto.

In the application concentration determination step S400, the application concentration determination module 400 determines a defective application state using the control signal of the integrated control module 500 when the application concentration value set in the application concentration analysis step S300 is out of a preset threshold reference value.

Specifically, the application concentration determination step S400 determines that the corresponding pixel is in a defective application state when the application concentration value set for each pixel is out of a preset threshold reference value. In this case, the preset threshold reference value is set to 50% according to the above-described technical features, but the present invention is not limited thereto. In addition, when a range of the application concentration is set to a range that may increase or decrease from the reference application concentration, for example, 50%, the range of the application concentration may be set to a range of the application concentration (threshold reference value, threshold reference value range) of 40% to 60% based on the reference application concentration. Obviously, the reference application concentration or the application concentration range using the same may be set differently for each workpiece and for each inspection region of the workpiece. That is, the application concentration determination step S400 may calculate an application concentration score of the corresponding inspection region for each preset inspection region of the workpiece by using a ratio of the number of pixels determined as the defective application state with respect to the total number of pixels in each region, and determine that the corresponding inspection region corresponds to the normal application state or the defective application state through the application concentration score by using a preset determination reference ratio.

For example, when ten pixels are included in the selected inspection region and seven pixels among the ten pixels have the application concentration value of equal to or less than 50%, the application concentration score of the corresponding inspection region is 70%, which is a ratio of the defective application state. The normal application state or defective application state of the corresponding inspection region is determined according to the preset determination reference ratio.

In this case, the preset determination reference ratio may also be set differently according to the purpose/function of the workpiece and the predetermined purpose/function of the coating solvent, but the present invention is not limited thereto. That is, according to the preset determination reference ratio, even if the ratio of the normal application state of all pixels with respect to the corresponding inspection region is only 30%, it may be determined as the normal application state.

However, when the defective application state is determined in any one region of the entire inspection region of the workpiece, the workpiece may be finally determined as a defective product.

That is, referring to FIG. 3, regions 1 to 3 are analyzed as normal application states, but region 4 is analyzed as a defective application state, so that as a result of the entire inspection of the workpiece, the workpiece is finally determined as a defective product.

For another example, an application concentration score of the corresponding region is calculated for each preset inspection region of the workpiece by using a ratio of a number of pixels determined as the defective application state with respect to a total number of pixels in each region, and a sum value or average value of the application concentration score for an entire inspection region of the workpiece is used to finally determine the workpiece as a defective product when the sum value or the average value is out of a preset value range.

In other words, when the ratios of the defective application states of the respective inspection regions are summed up or averaged and are out of the predetermined value range, the workpiece is finally determined as a defective product.

Accordingly, although it is not determined as the defective application state for the individual inspection regions, it may be analyzed that determination close to defective application has been made in a plurality of inspection regions when the total score (sum value or average value) is out of the predetermined value range.

In this case, the preset predetermined value may also be set differently according to the purpose/function of the workpiece and the predetermined purpose/function of the coating solvent, but the present invention is not limited thereto.

Further, the application state analysis method according to one embodiment of the present invention may output an alarm to the outside when the final determination result of the workpiece, which is obtained in the application concentration determining step S400, is a defective product.

In addition, the result processing module 600 may notify a defect through the integrated control module 500 connected to the Ethernet so that a follow-up action may be performed.

As described above, although the present invention has been described by limited embodiments and drawings, this is only provided to help general understanding of the present invention, but the present invention is not limited to the above embodiments, and various modifications and variations are possible from the technical spirit of the present invention by those skilled in the art to which the present invention pertains.

Therefore, the spirit of the present invention is not limited to the described embodiments, and all contents that are equivalent or equivalent to the claims to be described below belong to the scope of the present invention.

### DESCRIPTION OF REFERENCE NUMERALS

100: lighting module
200: vision module
300: application concentration analysis module
400: application concentration determination module
500: Integrated control module
600: result processing module

1. An application state analysis system for analyzing a surface application state of a workpiece to which a coating solvent is applied through an application unit, the application state analysis system comprising:
a lighting module configured to collectively control at least two light source units such that lights having mutually different spectral components are illuminated through the at least two light source units in a first light emitting state and a second light emitting state;
a vision module configured to photograph each workpiece on which the light is illuminated by the lighting module according to the light emitting state to acquire at least two image data;
an application concentration analysis module configured to calculate a color value for each pixel constituting each image data using a weight value preset for an RGB channel, and calculate a difference in the color value between matching pixels of the two image data to set the difference in the color value as an application concentration value of a corresponding pixel;
an application concentration determination module configured to determine a defective application state when the set application concentration value is out of a preset threshold reference value; and
an integrated control module configured to control each operation state by generating control signals for the lighting module, the vision module, the application concentration analysis module, and the application concentration determination module,

2. The application state analysis system of claim 1, wherein, upon an initial operation, the integrated control module controls the lighting module in a preset basic light emitting state, and controls the vision module to acquire basic image data about an entire region of the workpiece on which the light is illuminated according to the basic light emitting state.

3. The application state analysis system of claim 2, wherein the integrated control module analyzes the basic image data to generate a control signal for the first light emitting state, which has a spectrum that reflects the coating solvent applied to the workpiece, and generate a control signal for the second light emitting state, which has a spectrum that does not reflect the coating solvent applied to the workpiece, in order to control the lighting module.

4. The application state analysis system of claim 3, wherein the integrated control module analyzes the basic image data to perform additional control of the first and second light emitting states of the lighting module by generating a control signal for an illumination state for each preset inspection region of the workpiece.

5. The application state analysis system of claim 4, wherein the integrated control module sequentially generates the control signals for the lighting module, the vision module, the application concentration analysis module, and the application concentration determination module for each preset inspection region of the workpiece to separately control the operation state.

6. The application state analysis system of claim 5, wherein the vision module includes at least two lenses of mutually different types, and selectively acquires image data of the entire region, a preset wide inspection region, or a preset narrow inspection region of the workpiece according to the control signal of the integrated control module.

7. The application state analysis system of claim 1, wherein the application concentration analysis module detects feature points of each image data and matches pixels through feature point matching by using a pre-stored image processing technique.

8. The application state analysis system of claim 7, wherein the application concentration analysis module generates a mask based on the preset inspection region of the workpiece and performs a masking process on each image data by using a pre-stored image processing technique.

9. The application state analysis system of claim 5, wherein the application concentration determination module determines a normal application state or defective application state of a corresponding region for each preset inspection region of the workpiece by using a ratio of a number of pixels determined as the defective application state with respect to a total number of pixels in each region.

10. The application state analysis system of claim 9, wherein the application concentration determination module finally determines the workpiece as a defective product when the defective application state is determined in any one region of an entire inspection region of the workpiece.

11. The application state analysis system of claim 5, wherein the application concentration determination module
calculates an application concentration score of a corresponding region for each preset inspection region of the workpiece by using a ratio of a number of pixels determined as the defective application state with respect to a total number of pixels in each region, and
uses a sum value or average value of the application concentration score for an entire inspection region of the workpiece to finally determine the workpiece as a defective product when the sum value or the average value is out of a preset value range.

12. The application state analysis system of claim 10, further comprising a result processing module configured to output an alarm to an outside when a final determination result of the workpiece by the application concentration determination module is the defective product.

13. An application state analysis method for analyzing a surface application state of a workpiece to which a coating solvent is applied through an application unit, the application state analysis method comprising:
a lighting control step (S100) by a lighting module for collectively controlling at least two light source units such that lights having mutually different spectral components are illuminated through the at least two light source units in a first light emitting state and a second light emitting state by control signals;
a vision control step (S200) by a vision module for photographing each workpiece on which the light is illuminated according to the light emitting state in the lighting control step (S100) to acquire at least two image data using the control signal;
an application concentration analysis step (S300) by an application concentration analysis module for calculating a color value for each pixel constituting each image data, which is acquired in the vision control step (S200), using a weight value preset for an RGB channel, and calculating a difference in the color value between matching pixels of the two image data to set the difference in the color value as an application concentration value of a corresponding pixel using the control signal; and
an application concentration determination step (S400) by an application concentration determination module for determining a defective application state using the control signal when the application concentration value set in the application concentration analysis step (S300) is out of a preset threshold reference value,
wherein operations of the lighting control step (S100), the vision control step (S200), the application concentration analysis step (S300), and the application concentration determination step (S400) are sequentially repeated for each preset inspection region of the workpiece by the control signal.

14. The application state analysis method of claim 13, further comprising an entire image acquisition step (S10) for, upon an initial operation, integrally controlling the light source unit in a preset basic light emitting state using the control signal by the lighting module, and acquiring basic image data for an entire region of the workpiece on which the light is illuminated according to the basic light emitting state using the control signal by the vision module.

15. The application state analysis method of claim 14, further comprising a lighting control step (S20) for analyzing the basic image data obtained in the entire image acquisition step (S10) to generate a control signal for the first light emitting state having a spectrum that reflects the coating solvent applied to the workpiece and generate a control signal for the second light emitting state having a spectrum that does not reflect the coating solvent applied to the workpiece, in order to control the lighting module.

16. The application state analysis method of claim 15, further comprising a lighting addition control step (S30) for analyzing the basic image data obtained in the entire image acquisition step (S10) to generate a control signal for an illumination state in order to additionally control the first light emitting state and the second light emitting state of the lighting module for each predetermined inspection region of the workpiece.

17. The application state analysis method of claim 13, wherein the vision control step (S200) controls the vision module including at least two lenses of mutually different types to selectively acquire image data of an entire region, a preset wide inspection region, or a preset narrow inspection region of the workpiece.

18. The application state analysis method of claim 13, wherein the application concentration analysis step (S300) detects feature points of each image data and matches pixels through feature point matching by using a pre-stored image processing technique,

19. The application state analysis method of claim 18, wherein the application concentration analysis module generates a mask based on the preset inspection region of the workpiece and performs a masking process on each image data by using a pre-stored image processing technique.

20. The application state analysis method of claim 13, wherein the application concentration determination step (S400) determines a normal application state or defective application state of a corresponding region for each preset inspection region of the workpiece by using a ratio of a number of pixels determined as the defective application state with respect to a total number of pixels in each region.

21. The application state analysis method of claim 20, wherein the application concentration determination step (S400) finally determines the workpiece as a defective product when the defective application state is determined in any one region of an entire inspection region of the workpiece.

22. The application state analysis method of claim 13, wherein the application concentration determination step (S400)
calculates an application concentration score of a corresponding region for each preset inspection region of the workpiece by using a ratio of a number of pixels determined as the defective application state with respect to a total number of pixels in each region, and
uses a sum value or average value of the application concentration score for an entire inspection region of the workpiece to finally determine the workpiece as a defective product when the sum value or the average value is out of a preset value range.
